(19) United States
(12) Patent Application Publication
(10) Pub. No.: US 2005/0102150 A1
(43) Pub. Date: May 12, 2005

(54) SUBBAND ANALYSIS/SYNTHESIS FILTERING METHOD

(76) Inventors: Tzueng-Yau Lin, Tai-Chung Hsien (TW); Chien-Hua Hsu, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,209

(22) Filed: Oct. 28, 2004

(30) Foreign Application Priority Data
Nov. 7, 2003 (TW) 092131300

(51) Int. Cl. G10L 19/00

(52) U.S. Cl. 704/500

(57) ABSTRACT

An audio encoding/decoding method is capable of encoding an audio source signal and decoding a plurality of subband samples to generate a digital audio source signal. During the encoding process, the method generates a 0^{th} summation according to P windowed audio samples in accordance with 2P time domain intervals, generates a summation of a 1^{st} to an (M−1)th summations according to 2P windowed audio samples in accordance with the 2P time domain intervals, and calculates M subband samples according to the M summations. During the decoding process, the method reads M subband samples from a plurality of subband samples corresponding to a first index of a varied value to generate a digital audio source signal with an inverse modified discrete cosine transform and a synthetic operation.

### BACKGROUND

The present invention relates to an audio encoding/decoding method, and more particularly, to a subband analysis/synthesis filtering method.

As the operational speed of electronic circuits increases, operations such as audio/video processing fully utilizing system resources of electronic devices have become important. Specifications relating to audio/video processing include a plurality of encoding types to support various kinds of encoding requirements. For example, the MPEG specification includes a subband analysis/synthesis filtering definition for audio/video processing. For related information, please refer to ISO 11172-3, U.S. Pat. No. 5,214,678, U.S. Pat. No. 5,508,949, U.S. Pat. No. 5,809,474, U.S. Pat. No. 6,094,637, and “Fast subband filtering in MPEG audio coding” of IEEE Signal Processing Letter Vol. 1 No.2, February 1994.

In a subband analysis/synthesis filtering process according to the related art, both transformation matrixes of a Modified Discrete Cosine Transform (MDCT) and an Inverse MDCT (IMDCT) are non-square matrixes. Here a non-square matrix refers to the number of column elements being different from the number of row elements. For example, an audio source signal is first sampled to generate 32 audio samples. After a windowing operation, each of the thirty-two audio samples is multiplied with a corresponding windowing coefficient, and 32 windowed audio samples are correspondingly generated. Using a specific sampling mechanism, a circular buffer capable of storing 512 variables stores 512 windowed audio samples corresponding to 16 windowing operations. Please note, the number of subband samples needing to be generated is 32, which is the same as the number of the 32 audio samples. However, when the related art performs a summation operation on the windowed audio samples, the number of windowed audio samples used as vector elements for the summation operation is 64. Therefore, it is necessary to transform a summation vector having 64 elements into 32 subband samples using the MDCT matrix (the above-mentioned matrix of the MDCT) to complete the encoding of the audio source signal. As a result, an excessive operation load is introduced.

The subband analysis filtering method according to the related art reads eight encoding intermediate vectors from the circular buffer in units of 64 variables, wherein each encoding intermediate vector has 64 elements. And then, the summation operation of the encoding intermediate vectors is performed to generate a summation vector, wherein each element of the summation vector is a summation of corresponding elements of the encoding intermediate vectors. The summation vector is transformed into the 32 subband samples using the MDCT matrix. As many summation and multiplication operations must be performed, and because vector elements or matrix elements in these operations are not properly arranged, a large operation time is required. Furthermore, a pipelined Single Instruction Multiple Data (SIMD) operation of a Digital Signal Processor (DSP) is unable to be used to decrease the operation time. Additionally, access speed of discontinuously stored data is less than access speed of continuously stored data. When the vector elements or matrix elements are stored in a memory such as an external memory, it takes more time to access the discontinuously stored data. Therefore, an excessive amount of time is wasted during data access when using the subband analysis filtering method according to the related art.

The subband synthesis filtering method is basically an inverse operation of the subband analysis filtering method according to the related art. The inverse operation decodes the subband samples to generate a digital audio source signal. The 32 subband samples out of a plurality of subband samples generated through an encoding procedure are first processed using the above-mentioned IMDCT to generate a first decoding intermediate vector having 64 elements. Each element is a decoding intermediate sample of time domain. The first decoding intermediate vector is then stored in a First In First Out (FIFO) memory capable of storing 16 first decoding intermediate vectors, i.e. 1024 decoding intermediate samples. 512 decoding intermediate samples out of the 1024 decoding intermediate samples are read in units of 32 decoding intermediate samples in a specific order. After a windowing operation on the 512 decoding intermediate samples, 512 windowed decoding intermediate samples are generated. Every 32 windowed decoding intermediate samples are defined as a second decoding intermediate vector. Finally, a summation operation is performed on 16 second decoding intermediate vectors corresponding to the 512 windowed decoding intermediate samples to generate a decoding vector having 32 elements being the audio samples of the digital audio source signal. Similarly, many summation and multiplication operations must be performed in the decoding process mentioned above and a large storage volume of memory resources is required. Furthermore, as vector elements or matrix elements in these operations are not properly arranged, the above-mentioned pipelined SIMD operation is again not applicable. As such, when the vector elements or matrix elements are stored in a memory, the subband synthesis filtering method according to the related art wastes excessive time during data access.

In summary, the subband analysis/synthesis filtering process according to the related art must perform many summation and multiplication operations, and therefore a large storage volume of memory resources is required. Furthermore, as vector elements or matrix elements in these operations are not properly arranged, the above-mentioned pipelined SIMD operation is not applicable. Additionally, when the vector elements or matrix elements are stored in a memory, the related art wastes excessive time during data access.

### SUMMARY

It is therefore an objective of the present invention to provide a subband analysis/synthesis filtering method to solve the above-mentioned problems.

The present invention provides an audio processing method for encoding an audio source signal. In one embodiment, the method includes sampling the audio source signal in 2P time domain intervals to generate 2P*M audio samples, performing windowing operations on the 2P*M audio samples to generate 2P*M windowed audio samples correspondingly, generating a 0th summation according to P windowed audio samples in accordance with the 2P time domain intervals, generating a summation of a 1st to an (M−1 )th summations according to 2P windowed audio samples in accordance with the 2P time domain intervals, and calculating M subband samples according to the M summations. The generating steps and the calculating step are a combination of a summation operation and a Modified Discrete Cosine Transform (MDCT).

The present invention further provides an audio processing method for decoding a plurality of subband samples to generate a digital audio source signal. In another embodiment, the method includes reading M subband samples out of the plurality of subband samples in accordance with a first index, performing an Inverse MDCT (IMDCT) on the M subband samples to generate M outputs being M circular buffer variables of N circular buffer variables, and performing a synthetic operation according to a plurality of circular buffer variables out of the N circular buffer variables, where the synthetic operation is a combination of a windowing operation and a summation operation. The audio processing method further includes repeating the reading step with the first index varied to generate the digital audio source signal with the performing steps. The synthetic operation performing step performs a summation operation in accordance with the first index being varied, and both the IMDCT performing step and the synthetic operation performing step are executed eighteen times in accordance with the first index being varied to generate the digital audio source signal.

The present invention further provides an audio processing method being an audio encoding/decoding method capable of encoding an audio source signal and decoding a plurality of subband samples to generate a digital audio source signal. According to the embodiment, for encoding an audio source signal, steps of the method includes sampling the audio source signal in 2P time domain intervals to generate 2P*M audio samples, performing windowing operation on the 2P*M audio samples to generate 2P*M windowed audio samples correspondingly, generating a 0th summation according to P windowed audio samples in accordance with the 2P time domain intervals, generating a summation of a 1st to a (M−1 )th summations according to 2P windowed audio samples in accordance with the 2P time domain intervals, and calculating M subband samples according to the M summations. For decoding a plurality of subband samples, steps of the method includes reading M subband samples out of the plurality of subband samples in accordance with a first index, performing an IMDCT on the M subband samples to generate M outputs being M circular buffer variables of N circular buffer variables, performing a synthetic operation according to a plurality of circular buffer variables out of the N circular buffer variables, and repeating the reading step with the first index varied to generate the digital audio source signal with the IMDCT performing step and the synthetic operation performing step. The synthetic operation is a combination of a windowing operation and a summation operation.

It is an advantage of the present invention that the present invention method is capable of saving storage volume of memory resources.

It is another advantage of the present invention that vector elements or matrix elements in related operations are arranged sequentially so the present invention method could use the pipelined Single Instruction Multiple Data (SIMD) operation of a Digital Signal Processor (DSP).

It is another advantage of the present invention that when the vector elements or matrix elements are stored in a memory, the present invention method saves data access time.

These and other objectives of the present invention will no doubt become obvious to those of ordinary skill in the art after reading the following detailed description of the preferred embodiments illustrated in the various figures and drawings.

### BRIEF DESCRIPTION OF DRAWINGS

FIG. 1 is a flowchart of encoding an audio source signal according to an audio processing method of the present invention.

FIG. 2 is a flowchart of decoding a plurality of subband samples according to an audio processing method of the present invention.

FIG. 3 is a flowchart of audio encoding and audio decoding according to an audio processing method of the present invention.

### DETAILED DESCRIPTION

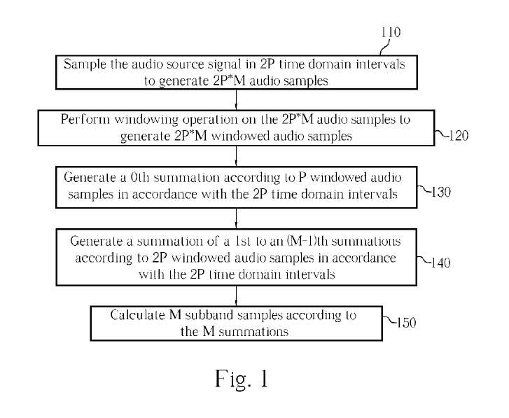

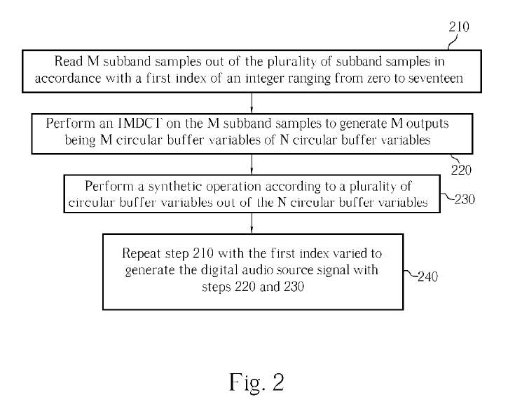

The present invention provides a subband analysis/synthesis filtering method. In the following paragraphs, the subband analysis filtering method of the present invention is first introduced using the encoding flowchart shown in FIG. 1, and the subband synthesis filtering method of the present invention is then introduced using the decoding flowchart shown in FIG. 2.

Please refer to FIG. 1 showing the encoding flowchart according to the first embodiment. The first embodiment provides an audio processing method for encoding an audio source signal. The method is described in this embodiment as using the following steps, however, the order of the steps is not a limitation of the present invention.

Step 110: Sample the audio source signal in 2P time domain intervals to generate 2P*M audio samples X, where X denotes a one-dimensional array, which can be referred to as X[0:(2P*M−1)]. Please note, in the following, X[n] denotes the (n)th element of the one-dimensional array.

Step 120: Perform windowing operation on the 2P*M audio samples X to generate 2P*M windowed audio samples.

Step 130: Generate a 0th summation Z[0] according to P windowed audio samples in accordance with the 2P time domain intervals, the 0th summation Z[0] corresponding to index i=0.

Step 140: Generate a summation Z[i] of a 1st to an (M−1 )th summations Z[1 :(M−1)] according to 2P windowed audio samples in accordance with the 2P time domain intervals, the 1st to (M−1 )th summations Z[1 :(M−1)] corresponding to index i=1˜(M−1), respectively.

Step 150: Calculate M subband samples S[0:(M−1)] according to the M summations Z[0:(M−1)].

Steps 110, 120 are performed in units of M audio samples, and initial values of the 2P*M audio samples X are zero, which is an initial state of the method. Steps 130, 140, and 150 are a combination of a summation operation and a Modified Discrete Cosine Transform (MDCT). Please note, in this embodiment, the audio processing method is in accordance with the MPEG specification. That is, the M subband samples S[0:(M−1)] are in accordance with the MPEG specification. In this embodiment, one may apply P=8 and M=32 for the purpose of comparing this embodiment to the related art.

In the first embodiment, each windowed audio sample is a product X[n]*C[n] of an audio sample X[n] out of the 2P*M audio samples X, and a windowing coefficient C[n] out of 2P*M windowing coefficients C. The 2P*M windowing coefficients C are in accordance with the MPEG specification and are well-known in the art. The summations Z[0:(M−1)] are:

$$Z [ i ] = {\sum }_{i = 0}^{p - 1} X [ \frac{1}{2} M + 2 Mj ] * C [ \frac{1}{2} M + 2 Mj ] , i = 0$$

$$Z [ i ] = {\sum }_{i = 0}^{p - 1} ( X [ \frac{1}{2} M + 2 i + 2 Mj ] * C [ \frac{1}{2} M + 2 i + 2 Mj ] ) + {\sum }_{i = 0}^{p - 1} ( X [ \frac{1}{2} M - 2 i + 2 Mj ] * C [ \frac{1}{2} M - 2 i + 2 Mj ] ) , \\ i = 1 ∼ \frac{1}{4} M$$

$$Z [ i ] = {\sum }_{i = 0}^{p - 1} ( X [ \frac{1}{2} M + 2 i + 2 Mj ] * C [ \frac{1}{2} M + 2 i + 2 Mj ] ) - {\sum }_{i = 0}^{p - 1} ( X [ \frac{5}{2} M - 2 i + 2 Mj ] * C [ \frac{5}{2} M - 2 i + 2 Mj ] ) , \\ i = \frac{1}{4} M + 1 ∼ \frac{1}{2} M - 1$$

$$Z [ i ] = {\sum }_{i = 0}^{p - 1} ( X [ - \frac{1}{2} M + 1 + 2 i + 2 Mj ] * C [ - \frac{1}{2} M + 1 + 2 i + 2 Mj ] ) + {\sum }_{i = 0}^{p - 1} ( X [ \frac{3}{2} M - 1 - 2 i + 2 Mj ] * C [ \frac{3}{2} M - 2 i + 2 Mj ] ) , \\ i = \frac{1}{2} M ∼ \frac{3}{4} M - 1$$

$$Z [ i ] = {\sum }_{i = 0}^{p - 1} ( X [ - \frac{1}{2} M + 1 + 2 i + 2 Mj ] * C [ - \frac{1}{2} M + 1 + 2 i + 2 Mj ] ) - {\sum }_{i = 0}^{p - 1} ( X [ - \frac{1}{2} M + 1 + 2 i + 2 Mj ] * C [ - \frac{1}{2} M + 1 - 2 i + 2 Mj ] ) , \\ i = \frac{3}{4} M ∼ M - 1$$

and the subband samples S[0:(M−1)] are:

$${S}_{i} = {\sum }_{k = 0}^{M / 2 - 1} {P}_{ik} * Z [ k ] + {\sum }_{k = 0}^{M / 2 - 1} {Q}_{ik} * Z [ k + M / 2 ]$$

$${S}_{M - 1 - i} = {\sum }_{k = 0}^{M / 2 - 1} {P}_{ik} * Z [ k ] - {\sum }_{k = 0}^{M / 2 - 1} {Q}_{ik} * Z [ k + M / 2 ] , i = 0 ∼ M / 2 - 1$$

$$where {P}_{ik} = cos [ \frac{π}{2 M} ( 2 i + 1 ) ( 2 k ) ] and {Q}_{ik} = cos [ \frac{π}{2 M} ( 2 i + 1 ) ( 2 k + 1 ) ] .$$

A second embodiment of the present invention is similar to the first embodiment with exceptions described as follows. In the second embodiment, each windowed audio sample is a product X[n]*C1 [n] of an audio sample X[n] out of the 2P*M audio samples X, and a windowing coefficient C1 [n] out of (2P*M−8) windowing coefficients C1. The windowing coefficients C1 are (2P*M−8) windowing coefficients selected from the 2P*M windowing coefficients C with a rearranged order. The method further includes providing the (2P*M−8) windowing coefficients C1, so the windowing coefficients C1 in the summations Z[0:(M−1)] can be applied using a pipelined Single Instruction Multiple Data (SIMD) operation or can be read sequentially from a memory such as an SRAM and a DRAM. The summations Z[0:(M−1)] are:

$$Z [ i ] = {\sum }_{i = 0}^{p - 1} X [ \frac{1}{2} M + 2 Mj ] * Cl [ j ] , i = 0$$

$$Z [ i ] = {\sum }_{i = 0}^{p - 1} ( X [ \frac{1}{2} M + 2 i + 2 Mj ] * Cl [ i * \frac{1}{2} M - \frac{1}{4} M + j ] ) + {\sum }_{i = 0}^{p - 1} ( X [ \frac{1}{2} M - 2 i + 2 Mj ] * Cl [ i * \frac{1}{2} M + j ] ) , \\ i = 1 \sim \frac{1}{4} M$$

$$Z [ i ] = {\sum }_{i = 0}^{p - 1} ( X [ \frac{1}{2} M + 2 i + 2 Mj ] * Cl [ i * \frac{1}{2} M - \frac{1}{4} M + j ] ) + {\sum }_{i = 0}^{p - 1} ( X [ \frac{5}{2} M - 2 i + 2 Mj ] * Cl [ i * \frac{1}{2} M + j ] ) , \\ i = \frac{1}{4} M + 1 \sim \frac{1}{2} M - 1$$

$$Z [ i ] = {\sum }_{i = 0}^{p - 1} ( X [ - \frac{1}{2} M + 1 + 2 i + 2 Mj ] * Cl [ i * \frac{1}{2} M - \frac{1}{4} M + j ] ) + {\sum }_{i = 0}^{p - 1} ( X [ \frac{3}{2} M - 1 - 2 i + 2 Mj ] * Cl [ i * \frac{1}{2} M + j ] ) , \\ i = \frac{1}{2} M \sim \frac{3}{4} M - 1$$

$$Z [ i ] = {\sum }_{i = 0}^{p - 1} ( X [ - \frac{1}{2} M + 1 + 2 i + 2 Mj ] * Cl [ i * \frac{1}{2} M - \frac{1}{4} M + j ] ) + {\sum }_{i = 0}^{p - 1} ( X [ - \frac{1}{2} M + 1 + 2 i + 2 Mj ] * Cl [ i * \frac{1}{2} M - \frac{1}{4} M + j ] ) , \\ i = \frac{3}{4} M \sim M - 1$$

and the subband samples S[0:(M−1)] are:

$${S}_{i} = {\sum }_{k = 0}^{M / 2 - 1} {P}_{ik} * Z [ k ] + {\sum }_{k = 0}^{M / 2 - 1} {Q}_{ik} * Z [ k + M / 2 ]$$

$${S}_{M - 1 - i} = {\sum }_{k = 0}^{M / 2 - 1} {P}_{ik} * Z [ k ] - {\sum }_{k = 0}^{M / 2 - 1} {Q}_{ik} * Z [ k + M / 2 ] , i = 0 ∼ M / 2 - 1$$

$$where {P}_{ik} = cos [ \frac{π}{2 M} ( 2 i + 1 ) ( 2 k ) ] and {Q}_{ik} = cos [ \frac{π}{2 M} ( 2 i + 1 ) ( 2 k + 1 ) ] .$$

Please note, the index (i * (M/2)−(M/4)+j) of the windowing coefficient C1 [i * (M/2)−(M/4)+j] of the first term in each equation of the summations Z[1 :(M−1)] are identical. Additionally, the index (i * (M/2)+j) of the windowing coefficient C1 [i * (M/2)+j] of the second term in each equation of the summations Z[1 :(M−1)] are identical. As a result, the above-mentioned rearrangement in the order introduces a direct access order of the (2P*M−8) windowing coefficients C1 while generating the summations Z[i] with the index i varies from 0 to (M−1) sequentially. Therefore, the present invention method is capable of reducing the required storage volume of memory resources for these operations and uses fewer windowing coefficients, i.e. the (2P*M−8) windowing coefficients C1, to complete the encoding process. In this embodiment, P=8, M=32, and the (2P*M−8) windowing coefficients are the 504 windowing coefficients C1 listed as follows.

C1 [504]={

-0.000002384, 0.000069618,-0.000021458,-0.004756451, 0.030526638, 0.0046381 95, 0.000747204, 0.000049591,

-0.000003338, 0.000050545,-0.000259876,-0.0061 89346, 0.029224873, 0.004489899, 0.000680923, 0.000043392,

-0.000001 907, 0.000084400, 0.0001 91689,-0.003411293, 0.031706810, 0.004728317, 0.000809669, 0.000055790,

-0.000003815, 0.000027180,-0.000522137,-0.007703304, 0.027815342, 0.004290581, 0.000611782, 0.000037670,

-0.000001430, 0.000095367, 0.000378609,-0.002161503, 0.032754898, 0.004752159, 0.000866413, 0.000062942,

-0.000004768,-0.000000954,-0.000806808,-0.009287834, 0.026310921, 0.004048824, 0.000542164, 0.000032425,

-0.000000954, 0.000102520, 0.000539303,-0.00101 1848, 0.033659935, 0.004703045, 0.000915051, 0.000070095,

-0.000006199,-0.000034332,-0.001111031,-0.010933399, 0.024725437, 0.003771 782, 0.000472546, 0.000027657,

-0.000000954, 0.000106812, 0.000674248, 0.000033379, 0.034412861, 0.004573822, 0.000954151, 0.000076771,

-0.000007629,-0.000072956,-0.001432419,-0.012627602, 0.023074150, 0.003467083, 0.000404358, 0.000023365,

-0.000000477,0.000108719,0.000783920,0.000971317, 0.035007000, 0.004357815, 0.000980854, 0.000083923,

-0.000009060,-0.000116348,-0.001766682,-0.014358521, 0.021372318, 0.003141880, 0.000339031, 0.000019550,

-0.000000477, 0.000108242, 0.000868797, 0.001 800537, 0.035435200, 0.004049301, 0.000994205, 0.000090599,

-0.000011444,-0.000165462,-0.002110004,-0.016112804, 0.01 9634247, 0.002803326, 0.000277042, 0.000016689,

-0.000000477,0.000105858,0.000930786,0.002521515, 0.035694122, 0.003643036, 0.000991821, 0.000096321,

-0.000013828,-0.000218868,-0.002457142,-0.017876148, 0.01 7876148, 0.002457142, 0.00021 8868, 0.000013828,

0.000000000,0.000101566,0.000971317,0.003134727, 0.035780907, 0.003134727, 0.000971317, 0.000101566,

-0.000016689,-0.000277042,-0.002803326,-0.01 9634247, 0.016112804,0.002110004,0.000165462, 0.000011444,

0.000096321, 0.000991821, 0.003643036, 0.035694122, 0.002521515, 0.000930786, 0.000105858,-0.000000477,

-0.000019550,-0.000339031,-0.003141880,-0.021372318, 0.014358521, 0.001766682, 0.000116348, 0.000009060,

0.000090599, 0.000994205, 0.004049301, 0.035435200, 0.001 800537, 0.000868797, 0.000108242,-0.000000477,

-0.000023365,-0.000404358,-0.003467083,-0.023074150, 0.01 2627602, 0.00143241 9, 0.000072956, 0.000007629,

0.000083923, 0.000980854, 0.004357815, 0.035007000, 0.000971317, 0.000783920, 0.000108719,-0.000000477,

-0.000027657,-0.000472546,-0.003771 782,-0.024725437, 0.010933399, 0.001111031, 0.000034332, 0.000006199,

0.000076771, 0.000954151, 0.004573822, 0.034412861, 0.000033379, 0.000674248, 0.000106812,-0.000000954,

-0.000032425,-0.000542164,-0.004048824,-0.026310921, 0.009287834, 0.000806808, 0.000000954, 0.000004768,

0.000070095,0.000915051,0.004703045, 0.033659935,- 0.001011 848, 0.000539303, 0.000102520,-0.000000954,

-0.000037670,-0.000611782,-0.004290581,-0.027815342, 0.007703304, 0.000522137,-0.0000271 80, 0.000003815,

0.000062942,0.000866413,0.004752159,0.032754898,- 0.002161503, 0.000378609, 0.000095367,-0.000001430,

-0.000043392,-0.000680923,-0.004489899,-0.029224873, 0.0061 89346, 0.000259876,-0.000050545, 0.000003338,

0.000055790,0.000809669,0.004728317,0.031706810,- 0.003411293, 0.0001 91689, 0.000084400,-0.000001 907,

-0.000002861,0.000060558,-0.000137329,-0.005462170, 0.029890060, 0.004570484, 0.000714302, 0.000046253,

-0.000002384,0.000077724,0.000088215,-0.004072189, 0.031132698, 0.004691124, 0.000779152, 0.000052929,

-0.000003338, 0.000039577,-0.000388145,-0.006937027, 0.028532982, 0.004395962, 0.000646591, 0.000040531,

-0.000001 907, 0.000090122, 0.000288486,-0.002774239, 0.032248020, 0.004748821, 0.000838757, 0.000059605,

-0.000004292, 0.000013828,-0.000661 850,-0.008487225, 0.027073860, 0.004174709, 0.000576973, 0.000034809,

-0.000001430,0.000099182,0.000462532,-0.001573563, 0.033225536, 0.004737377, 0.000891685, 0.000066280,

-0.000005245,-0.000017166,-0.000956535,-0.010103703, 0.025527000, 0.003914356, 0.000507355, 0.000030041,

-0.000000954, 0.000105381, 0.000610352,-0.000475883, 0.034055710, 0.004649162, 0.000935555, 0.000073433,

-0.000006676,-0.000052929,-0.001269817,-0.011775017, 0.0239071 85, 0.003622532, 0.000438213, 0.000025272,

-0.000000954,0.000108242,0.000731945,0.000515938, 0.034730434, 0.004477024, 0.000968933, 0.000080585,

-0.000008106,-0.000093937,-0.001597881,-0.013489246, 0.022228718, 0.003306866, 0.000371456, 0.000021458,

-0.000000477,0.000108719,0.000829220,0.001399517, 0.035242081, 0.004215240, 0.000989437, 0.000087261,

-0.000010014,-0.000140190,-0.001937389,-0.015233517, 0.020506859, 0.002974033, 0.000307560, 0.00001 8120,

-0.000000477, 0.000107288, 0.000902653, 0.002174854, 0.035586357, 0.003858566, 0.000995159, 0.000093460,

-0.000012398,-0.000191212,-0.002283096,-0.016994476, 0.01 8756866, 0.002630711, 0.000247479, 0.000014782,

-0.000000477, 0.000103951, 0.000953674, 0.002841473, 0.035758972, 0.003401 756, 0.000983715, 0.0000991 82,

-0.000014782,-0.000247479,-0.002630711,-0.01 8756866, 0.016994476, 0.002283096, 0.000191212, 0.000012398,

0.000099182,0.000983715,0.003401756,0.035758972, 0.002841473, 0.000953674, 0.000103951,-0.000000477,

-0.00001 8120,-0.000307560,-0.002974033,-0.020506859, 0.015233517, 0.001937389, 0.000140190, 0.000010014,

0.000093460, 0.000995159, 0.003858566, 0.035586357, 0.002174854, 0.000902653, 0.000107288,-0.000000477,

-0.000021458,-0.000371456,-0.003306866,-0.022228718, 0.01 3489246, 0.001 597881, 0.000093937, 0.000008106,

0.000087261, 0.000989437, 0.004215240, 0.035242081, 0.001399517, 0.000829220, 0.000108719,-0.000000477,

-0.000025272,-0.000438213,-0.003622532,-0.023907185, 0.011775017, 0.001269817, 0.000052929, 0.000006676,

0.000080585, 0.000968933, 0.004477024, 0.034730434, 0.000515938, 0.000731945, 0.000108242,-0.000000954,

-0.000030041,-0.000507355,-0.003914356,-0.025527000, 0.010103703, 0.000956535, 0.000017166, 0.000005245,

0.000073433,0.000935555,0.004649162,0.034055710,- 0.000475883, 0.000610352, 0.000105381,-0.000000954,

-0.000034809,-0.000576973,-0.004174709,-0.027073860, 0.008487225, 0.000661 850,-0.000013828, 0.000004292,

0.000066280,0.000891685,0.004737377,0.033225536,- 0.001 573563, 0.000462532, 0.0000991 82,-0.000001430,

-0.000040531,-0.000646591,-0.004395962,-0.028532982, 0.006937027, 0.000388145,-0.000039577, 0.000003338,

0.000059605, 0.000838757, 0.004748821, 0.032248020,- 0.002774239, 0.000288486, 0.000090122,-0.000001 907,

-0.000046253,-0.000714302,-0.004570484,-0.029890060, 0.005462170, 0.000137329,-0.000060558, 0.000002861,

0.000052929, 0.000779152, 0.004691124, 0.031132698,- 0.0040721 89, 0.00008821 5, 0.000077724,-0.000002384

}

A third embodiment of the present invention is described as follows. Please refer to FIG. 2 showing the decoding flowchart. The present invention provides an audio processing method for decoding a plurality of subband samples xr[m] to generate a digital audio source signal. The method could take advantage of pipelined SIMD operation of a Digital Signal Processor (DSP). The method is described in this embodiment as using the following steps, however, the order of the steps is not a limitation of the present invention.

Step 210: Read M subband samples xr[18q+p] out of the plurality of subband samples xr[m] in accordance with a first index p of an integer ranging from zero to seventeen, where q is an integer ranging from (M−1) to zero.

Step 220: Perform an Inverse MDCT (IMDCT) on the M subband samples xr[18q+p] to generate M outputs being M circular buffer variables vs[n] of N circular buffer variables vs[n].

Step 230: Perform a synthetic operation according to a plurality of circular buffer variables vs[n] out of the N circular buffer variables vs[n], where the synthetic operation is a combination of a windowing operation and a summation operation.

Step 240: Repeat step 210 with the first index p varied to generate the digital audio source signal with steps 220 and 230.

In step 220, the M outputs generated each time by the IMDCT are arranged in reversed order, the order corresponding to q=(M−1)˜0, and the M outputs are M continuous circular buffer variables vs[n] of the N circular buffer variables vs[n]. The N circular buffer variables vs[n] can be stored in a circular buffer, and therefore, the M outputs generated by the IMDCT each time are stored in the circular buffer in the reversed order. Step 230 performs a summation operation in accordance with the first index p being varied from 0 to 17, and both steps 220 and 230 are executed eighteen times in accordance with the first index p being varied from 0 to 17 to generate the digital audio source signal. Please note, the audio processing method is in accordance with the MPEG specification. That is, the plurality of subband samples xr[m] are in accordance with the MPEG specification. In this embodiment, one may apply N=512 and M=32 for the purpose of comparing this embodiment to the related art. The IMDCT is:

for (i = 3M/2; i >= M/2 + 1; i−−)
{
vs1 [−−vsi] = 0;
for (j = 0; j < M; j++)

vs1 [vsi] +=cos (PI / 2M * (i + M/2) *
(2 * j + 1)) * xr[18M + 18 * j

+ p];

}

where PI denotes ratio of the circumference of a circle to its diameter. And the synthetic operation is:

for (j = 0; j <= M / 2 − 1; j++)
{
ps[M * p + j] = 0;
for (i = 0; i < M / 2; i += 2)
ps[M * p + j] += (−d[M * i + j] *vs[vsi+M * i + M / 2 − 1 − j] );
for (i = 1; i <= M / 2 − 1; i += 2)
ps[M * p + j] += (d[M * i + j] *vs[vsi+M * i + M / 2 − 1 + j]);

}

ps[18 * M + M * p + M / 2] = 0;
for (i = 1; i <= M / 2 − 1; i += 2)
ps[M * p + M / 2] += (d[M * i + M / 2] * vs[vsi+M *
i + M / 2 − 1 +

M / 2] );

for (j = M / 2 + 1; j <= M − 1; j++)

{

ps[18 * M + M * p + j] = 0;

for (i = 0; i < M / 2; i += 2)

ps[M * p + j] += (d[M * i + j] * vs[vsi+M * i +
j − M / 2 + 1] );

for (i = 1; i <= M / 2 − 1; i += 2)

ps[M * p + j] += (d[M * i + j] * vs[vsi+M * i +
3M/2 − 1 − j] );

}

where the audio samples ps[n] are the audio samples ps[n] of the digital audio source signal, and the windowing coefficients d[n] are the windowing coefficients d[n] of the windowing operation.

A fourth embodiment of the present invention is similar to the third embodiment with exceptions described as follows. In the fourth embodiment, the number of the windowing coefficients d[n] of the windowing operation is equal to (N/2+1). As a result, the present invention method is capable of reducing the storage volume of memory resources and reducing access time of the windowing coefficients d[n] during decoding. In this embodiment, one may apply N=512 and M=32 for the purpose of comparing this embodiment to the related art. The IMDCT is:

for (i = 3M/2; i >= M/2 + 1; i−−)
{
vs1 [−−vsi] = 0;
for (j = 0; j < M; j++)

vs1 [vsi] +=cos (PI / 2M * (i + M/2) * (2 * j + 1)) *
xr[18M + 18 * j

+ p];

}

where PI denotes ratio of the circumference of a circle to its diameter. And the synthetic operation is:

j = 0;
ps[M * p + j] = 0;
for (i = 0; i < M / 4; i += 2)
ps[M * p + j] += (−d[M * i + j] *vs[(vsi + M * i + M / 2 − 1 − j) ]);
for (i = M / 4; i < M / 2; i += 2)
ps[M * p + j] += (−d[N − M * i − j] *vs[( vsi+ M * i + M / 2 − 1 − j) ]);
for (i = 1; i < M / 4 + 1; i += 2)
ps[M * p + j] += (d[M * i + j] * vs[(vsi++ M * i + M / 2 − 1 + j) ]);
for (i = M / 4 + 1; i <= M / 2 − 1; i += 2)
ps[M * p + j] += (−d[N − M * i − j] *vs[(vsi + M * i + M / 2 − 1 + j) ]);
for (j = 1; j <= M / 2 − 1; j++)
{
ps[M * p + j] = 0;
for (i = 0; i < M / 4; i += 2)
ps[18 * M + M * p +j] += (−d[M * i + j] *vs[(vsi + M * i + M / 2 − 1

− j) ]);

for (i = 8; i < M / 2; i += 2)
ps[M * p + j] += (d[N − M * i − j] *vs[(vsi + M * i + M / 2 − 1 − j) ]);
for (i = 1; i < M / 4 + 1; i += 2)
ps[M * p + j] += (d[M * i + j] *vs[(vsi + M * i + M / 2 − 1 + j) ]);
for (i = M / 4 + 1; i <= M / 2 − 1; i += 2)
ps[M * p + j] += (−d[N − M * i − j] *vs[(vsi + M * i + M / 2 − 1 + j) ]);
}
ps[M * p + M / 2] = 0;
for (i = 1; i < M / 4 + 1; i += 2)
ps[M * p + M / 2] += (d[M * i + M / 2] *vs[(vsi + M * i + M / 2 − 1

+ M / 2) ]);

for (i = M / 4 + 1; i <= M / 2 − 1; i += 2)
ps[ M * p + M / 2] += (−d[N − M * i − M / 2] *vs[(vsi + M * i + M / 2

− 1 + M / 2) ]);

for (j = M / 2 + 1; j <= M − 1; j++)
{
ps[M * p + j] = 0;
for (i = 0; i < M / 4; i += 2)
ps[18 * M + M * p +j] += (d[M * i + j] *vs[(vsi + M * i + j − M / 2 +

1) ]);

for (i = M / 4; i < M / 2; i += 2)
ps[M * p + j] += (−d[N − M * i − j] *vs[( vsi+ M * i + j − M / 2 + 1) ]);
for (i = 1; i < M / 4 + 1; i += 2)
ps[M * p + j] += (d[M * i + j] *vs[( vsi+ M * i + 3M/2 − 1 − j) ]);
for (i = M / 4 + 1; i <= M / 2 − 1; i += 2)
ps[M * p + j] += (−d[N − M * i − j] *vs[( vsi+ M * i + 3M/2 − 1 − j) ]);
}

where the audio samples ps[n] are the audio samples ps[n] of the digital audio source signal.

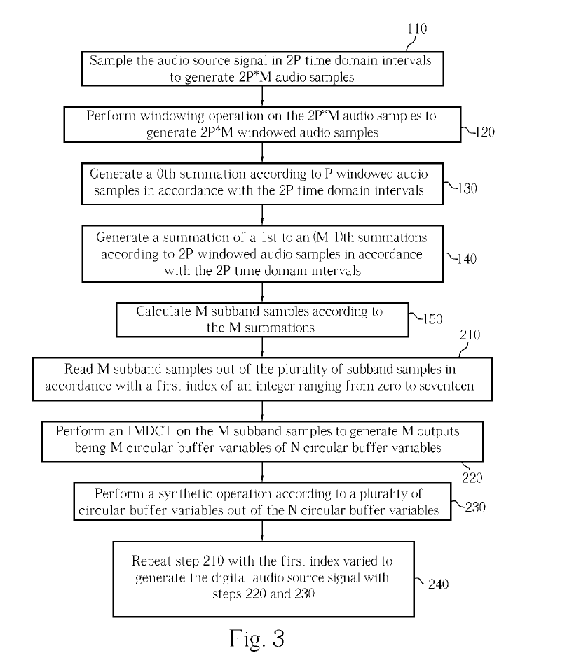

Please refer to FIG. 3 showing a flowchart of audio encoding and audio decoding according to an audio processing method of the fifth embodiment. The flowchart shown in Fig. illustrates a combination of the encoding flowchart shown in FIG. 1 and the decoding flowchart shown in FIG. 2. As long as the implementation of the present invention is not hindered, the order of the steps shown in FIG. 3 is not a limitation of the present invention. Repeated descriptions relating to the steps shown in FIG. 3 are omitted.

In contrast to the related art, the present invention method is capable of reducing the storage volume of memory resources. Vector elements or matrix elements in related operations of the present invention are arranged sequentially so the present invention method could utilize the pipelined SIMD operation of a DSP. Furthermore, when the vector elements or matrix elements are stored in a storage device such as a memory, the present invention method saves data access time comparing to the related art.

Those skilled in the art will readily observe that numerous modifications and alterations of the device may be made while retaining the teachings of the invention. Accordingly, the above disclosure should be construed as limited only by the metes and bounds of the appended claims.

1. An audio processing method for encoding an audio source signal, the method comprising:
(a) sampling the audio source signal in 2P time domain intervals to generate 2P*M audio samples;
(b) performing a windowing operation on the 2P*M audio samples to generate 2P*M windowed audio samples;
(c) generating a 0^{th} summation according to P windowed audio samples in accordance with the 2P time domain intervals;
(d) generating a summation of a 1^{st} to an (M−1)th summations according to 2P windowed audio samples in accordance with the 2P time domain intervals; and
(e) calculating M subband samples according to the M summations.

2. The method of claim 1, wherein steps (c), (d), and (e) are a combination of a summation operation and a Modified Discrete Cosine Transform (MDCT).

3. The method of claim 1, wherein each windowed audio sample is a product of an audio sample out of the 2P*M audio samples and a windowing coefficient out of (2P*M−8) windowing coefficients, the method further comprising:
(f) providing the (2P*M−8) windowing coefficients, so the windowing coefficients in the summations can be applied using a pipelined Single Instruction Multiple Data (SIMD) operation or can be read sequentially from a storage device.

4. The method of claim 3, wherein the audio samples are audio samples X[n], the windowing coefficients in step (f) are the windowing coefficients C1 [n], the summations are:
$$Z [ i ] = {\sum }_{i = 0}^{p - 1} X [ \frac{1}{2} M + 2 Mj ] * Cl [ j ] , i = 0$$
$$Z [ i ] = {\sum }_{i = 0}^{p - 1} ( X [ \frac{1}{2} M + 2 i + 2 Mj ] * Cl [ i * \frac{1}{2} M - \frac{1}{4} M + j ] ) + {\sum }_{i = 0}^{p - 1} ( X [ \frac{1}{2} M - 2 i + 2 Mj ] * Cl [ i * \frac{1}{2} M + j ] ) , \\ i = 1 \sim \frac{1}{4} M$$
$$Z [ i ] = {\sum }_{i = 0}^{p - 1} ( X [ \frac{1}{2} M + 2 i + 2 Mj ] * Cl [ i * \frac{1}{2} M - \frac{1}{4} M + j ] ) + {\sum }_{i = 0}^{p - 1} ( X [ \frac{5}{2} M - 2 i + 2 Mj ] * Cl [ i * \frac{1}{2} M + j ] ) , \\ i = \frac{1}{4} M + 1 \sim \frac{1}{2} M - 1$$
$$Z [ i ] = {\sum }_{i = 0}^{p - 1} ( X [ - \frac{1}{2} M + 1 + 2 i + 2 Mj ] * Cl [ i * \frac{1}{2} M - \frac{1}{4} M + j ] ) + {\sum }_{i = 0}^{p - 1} ( X [ \frac{3}{2} M - 1 - 2 i + 2 Mj ] * Cl [ i * \frac{1}{2} M + j ] ) , \\ i = \frac{1}{2} M \sim \frac{3}{4} M - 1$$
$$Z [ i ] = {\sum }_{i = 0}^{p - 1} ( X [ - \frac{1}{2} M + 1 + 2 i + 2 Mj ] * Cl [ i * \frac{1}{2} M - \frac{1}{4} M + j ] ) + {\sum }_{i = 0}^{p - 1} ( X [ - \frac{1}{2} M + 1 + 2 i + 2 Mj ] * Cl [ i * \frac{1}{2} M - \frac{1}{4} M + j ] ) , \\ i = \frac{3}{4} M \sim M - 1$$
and the subband samples are:
$${S}_{i} = {\sum }_{k = 0}^{M / 2 - 1} {P}_{ik} * Z [ k ] + {\sum }_{k = 0}^{M / 2 - 1} {Q}_{ik} * Z [ k + M / 2 ]$$
$${S}_{M - 1 - i} = {\sum }_{k = 0}^{M / 2 - 1} {P}_{ik} * Z [ k ] - {\sum }_{k = 0}^{M / 2 - 1} {Q}_{ik} * Z [ k + M / 2 ] , i = 0 ∼ M / 2 - 1$$
$$wherein {P}_{ik} = cos [ \frac{π}{2 M} ( 2 i + 1 ) ( 2 k ) ] and {Q}_{ik} = cos [ \frac{π}{2 M} ( 2 i + 1 ) ( 2 k + 1 ) ]$$

5. The method of claim 1, wherein the audio samples are audio samples X[n]; each windowed audio sample is a product of an audio sample X[n] out of the 2P*M audio samples, and a windowing coefficient C[n] out of 2P*M windowing coefficients; the summations are:
$$Z [ i ] = {\sum }_{i = 0}^{p - 1} X [ \frac{1}{2} M + 2 Mj ] * C [ \frac{1}{2} M + 2 Mj ] , i = 0$$
$$Z [ i ] = {\sum }_{i = 0}^{p - 1} ( X [ \frac{1}{2} M + 2 i + 2 Mj ] * C [ \frac{1}{2} M + 2 i + 2 Mj ] ) + {\sum }_{i = 0}^{p - 1} ( X [ \frac{1}{2} M - 2 i + 2 Mj ] * C [ \frac{1}{2} M - 2 i + 2 Mj ] ) , \\ i = 1 ∼ \frac{1}{4} M$$
$$Z [ i ] = {\sum }_{i = 0}^{p - 1} ( X [ \frac{1}{2} M + 2 i + 2 Mj ] * C [ \frac{1}{2} M + 2 i + 2 Mj ] ) - {\sum }_{i = 0}^{p - 1} ( X [ \frac{5}{2} M - 2 i + 2 Mj ] * C [ \frac{5}{2} M - 2 i + 2 Mj ] ) , \\ i = \frac{1}{4} M + 1 ∼ \frac{1}{2} M - 1 ;$$
$$Z [ i ] = {\sum }_{i = 0}^{p - 1} ( X [ - \frac{1}{2} M + 1 + 2 i + 2 Mj ] * C [ - \frac{1}{2} M + 1 + 2 i + 2 Mj ] ) + {\sum }_{i = 0}^{p - 1} ( X [ \frac{3}{2} M - 1 - 2 i + 2 Mj ] * C [ \frac{3}{2} M - 2 i + 2 Mj ] ) , \\ i = \frac{1}{2} M ∼ \frac{3}{4} M - 1$$
$$Z [ i ] = {\sum }_{i = 0}^{p - 1} ( X [ - \frac{1}{2} M + 1 + 2 i + 2 Mj ] * C [ - \frac{1}{2} M + 1 + 2 i + 2 Mj ] ) - {\sum }_{i = 0}^{p - 1} ( X [ - \frac{1}{2} M + 1 + 2 i + 2 Mj ] * C [ - \frac{1}{2} M + 1 - 2 i + 2 Mj ] ) , \\ i = \frac{3}{4} M ∼ M - 1$$
and the subband samples are:
$${S}_{i} = {\sum }_{k = 0}^{M / 2 - 1} {P}_{ik} * Z [ k ] + {\sum }_{k = 0}^{M / 2 - 1} {Q}_{ik} * Z [ k + M / 2 ]$$
$${S}_{M - 1 - i} = {\sum }_{k = 0}^{M / 2 - 1} {P}_{ik} * Z [ k ] - {\sum }_{k = 0}^{M / 2 - 1} {Q}_{ik} * Z [ k + M / 2 ] , i = 0 ∼ M / 2 - 1$$
$$wherein {P}_{ik} = cos [ \frac{π}{2 M} ( 2 i + 1 ) ( 2 k ) ] and {Q}_{ik} = cos [ \frac{π}{2 M} ( 2 i + 1 ) ( 2 k + 1 ) ] .$$

6. The method of claim 1, wherein the audio processing method is in accordance with the MPEG specification.

7. The method of claim 1, wherein steps (a) and (b) are performed in units of M audio samples, and initial values of the 2P*M audio samples are zero being an initial state of the method.

8. An audio processing method for decoding a plurality of subband samples to generate a digital audio source signal, the method comprising:
(a) reading M subband samples out of the plurality of subband samples in accordance with a first index;
(b) performing an Inverse Modified Discrete Cosine Transform (IMDCT) on the M subband samples to generate M outputs being M circular buffer variables of N circular buffer variables;
(c) performing a synthetic operation according to a plurality of circular buffer variables out of the N circular buffer variables, wherein the synthetic operation is a combination of a windowing operation and a summation operation; and
(d) repeating step (a) with the first index varied to generate the digital audio source signal with steps (b) and (c).

9. The method of claim 8, wherein step (c) performs a summation operation in accordance with the first index being varied.

10. The method of claim 8, wherein steps (b) and (c) are executed eighteen times in accordance with the first index being varied to generate the digital audio source signal.

11. The method of claim 8, wherein the N circular buffer variables are stored in a circular buffer.

12. The method of claim 11, wherein the M outputs generated each time by the IMDCT are stored in the circular buffer in a reversed order.

13. The method of claim 8, wherein the M outputs generated each time by the IMDCT are arranged in a reversed order, and the M outputs are M continuous circular buffer variables of the N circular buffer variables.

14. The method of claim 8, wherein the plurality of subband samples are the plurality of subband samples xr[m], the first index is the first index p of an integer ranging from zero to seventeen, and step (a) reads M subband samples xr[18q+p], where q is an integer ranging from (M−1) to zero.

15. The method of claim 8, wherein the number of windowing coefficients of the windowing operation is (N/2+1).

16. The method of claim 15, wherein the plurality of subband samples are the plurality of subband samples xr[m]; the first index is the first index p of an integer ranged from zero to seventeen; step (a) reads M subband samples xr[18q+p], wherein q is an integer ranging from (M−1) to zero; the N circular buffer variables are the N circular buffer variables vs[n]; the IMDCT is:
for (i = 3M/2; i >= M/2 + 1; i−−)
{
vs1 [−−vsi] = 0;
for (j = 0; j < M; j++)
vs1 [vsi] +=cos (PI / 2M * (i + M/2) * (2 * j + 1)) *
xr[18M + 18 * j + p];
}
and the synthetic operation is:
j = 0;
ps[M * p + j] = 0;
for (i = 0; i < M / 4; i += 2)
ps[M * p + j] += (−d[M * i + j] *vs[( vsi+ M * i + M / 2 − 1 − j) ]);
for (i = M / 4; i < M / 2; i += 2)
ps[M * p + j] += (−d[N − M * i − j] *vs[(vsi + M * i + M / 2 − 1 − j) ]);
for (i = 1; i < M / 4 + 1; i += 2)
ps[M * p + j] += (d[M * i + j] * vs[( vsi+ M * i + M / 2 − 1 + j) ]);
for (i = M / 4 + 1; i <= M / 2 − 1; i += 2)
ps[M * p + j] += (−d[N − M * i − j] *vs[(vsi + M * i + M / 2 − 1 + j) ]);
for (j = 1; j <= M / 2 − 1; j++)
{
ps[M * p + j] = 0;
for (i = 0; i < M / 4; i += 2)
ps[18 * M + M * p + j] += (−d[M * i + j] *vs[( vsi+ M * i + M / 2 − 1 − j) ]);
for (i = 8; i < M / 2; i += 2)
ps[M * p + j] += (d[N − M * i − j] *vs[( vsi+ M * i + M / 2 − 1 − j) ]);
for (i = 1; i < M / 4 + 1; i += 2)
ps[M * p + j] += (d[M * i + j] *vs[( vsi+ M * i + M / 2 − 1 + j) ]);
for (i = M / 4 + 1; i <= M / 2 − 1; i += 2)
ps[M * p + j] += (−d[N − M * i − j] *vs[(vsi + M * i + M / 2 − 1 + j) ]);
}
ps[M * p + M / 2] = 0;
for (i = 1; i < M / 4 + 1; i += 2)
ps[M * p + M / 2] += (d[M * i + M / 2] *vs[( vsi+ M * i + M / 2 − 1 + M / 2) ]);
for (i = M / 4 + 1; i <= M / 2 − 1; i += 2)
ps[ M * p + M / 2] += (−d[N − M * i − M / 2] *vs[( vsi+ M * i + M / 2 − 1 + M / 2) ]);
for (j = M / 2 + 1; j <= M − 1; j++)
{
ps[M * p + j] = 0;
for (i = 0; i < M / 4; i += 2)
ps[18 * M + M * p + j] += (d[M * i + j] *vs[( vsi+ M * i + j − M / 2 + 1 ) ]);
for (i = M / 4; i < M / 2; i += 2)
ps[M * p + j] += (−d[N − M * i − j] *vs[( vsi + M * i + j − M / 2 + 1 ) ]);
for (i = 1; i < M / 4 + 1; i += 2)
ps[M * p + j] += (d[M * i + j] *vs[( vsi+ M * i + 3M/2 − 1 − j) ]);
for (i = M / 4 + 1; i <= M / 2 − 1; i += 2)
ps[M * p + j] += (−d[N − M * i − j] *vs[( vsi+ M * i + 3M/2 − 1 − j) ]);
}
wherein the audio samples ps[n] are the audio samples ps[n] of the digital audio source signal, and the windowing coefficients d[n] are the windowing coefficients d[n] of the windowing operation.

17. The method of claim 8, wherein the plurality of subband samples are the plurality of subband samples xr[m]; the first index is the first index p of an integer ranging from zero to seventeen; step (a) reads M subband samples xr[18q+p], where q is an integer ranging from (M−1) to zero; the N circular buffer variables are the N circular buffer variables vs[n]; the IMDCT is:
for (i = 3M/2; i >= M/2 + 1; i−−)
{
vs1 [−−vsi] = 0;
for (j = 0; j < M; j++)
vs1 [vsi] +=cos (PI / 2M * (i + M/2) * (2 * j + 1)) *
xr[18M + 18 * j + p];
}
and the synthetic operation is:
for (j = 0; j <= M / 2 − 1; j++)
{
ps[M * p + j] = 0;
for (i = 0; i < M / 2; i += 2)
ps[M * p + j] += (−d[M * i + j] *vs[vsi+M * i + M /
2 − 1 − j] );
for (i = 1; i <= M / 2 − 1; i += 2)
ps[M * p + j] += (d[M * i + j] *vs[vsi+M * i + M /
2 − 1 + j]);
}
ps[18 * M + M * p + M / 2] = 0;
for (i = 1; i <= M / 2 − 1; i += 2)
ps[M * p + M / 2] += (d[M * i + M / 2] * vs[vsi+M *
i + M / 2 − 1 + M / 2] );
for (j = M / 2 + 1; j <= M − 1; j++)
{
ps[18 * M + M * p + j] = 0;
for (i = 0; i < M / 2; i += 2)
ps[M * p + j] += (d[M * i + j] * vs[vsi+M *
i + j − M / 2 + 1] );
for (i = 1; i <= M / 2 − 1; i += 2)
ps[M * p + j] += (d[M * i + j] * vs[vsi+M * i +
3M/2 − 1 − j] );
}
wherein the audio samples ps[n] are the audio samples ps[n] of the digital audio source signal, and the windowing coefficients d[n] are the windowing coefficients d[n] of the windowing operation.

18. The method of claim 8, wherein the audio processing method is in accordance with the MPEG specification.

19. The method of claim 8, wherein the method is compatible with a pipelined Single Instruction Multiple Data (SIMD) operation of a Digital Signal Processor (DSP).

20. The method of claim 8, wherein the method is an audio encoding/decoding method capable of encoding an audio source signal, the method further comprising:
sampling the audio source signal in 2P time domain intervals to generate 2P*M audio samples;
performing a windowing operation on the 2P*M audio samples to generate 2P*M windowed audio samples;
generating a 0^{th} summation according to P windowed audio samples in accordance with the 2P time domain intervals;
generating a summation of a 1^{st} to a (M−1 )th summations according to 2P windowed audio samples in accordance with the 2P time domain intervals; and
calculating M subband samples according to the M summations.
